(19) United States
(12) Patent Application Publication
(10) Pub. No.: US 2015/0375306 A1
(43) Pub. Date: Dec. 31, 2015

(54) Vibrating System

(71) Applicants: CENTRE NATIONAL DE LA RECHERCHE SCIENTIFIQUE, Paris, Cedex 16 (FR); UNIVERSITÉ DE BORDEAUX, Bordeaux (FR); INSTITUT POLYTECHNIQUE DE BORDEAUX, Talence (FR)

(72) Inventors: Jérémy Jallageas, Bordeaux (FR); Mehdi Cherif, Cestas Rejouit (FR); Olivier Cahuc, Canejan (FR); Jean-Yves K'Nevez, Bouliac (FR)

(21) Appl. No.: 14/767,440

(22) PCT Filed: Jan. 23, 2014
(86) PCT No.: PCT/FR2014/050126

§ 371 Date: Aug. 12, 2015

(30) Foreign Application Priority Data
Feb. 12, 2013 (FR) 1351198

(51) Int. Cl. B23B 47/34; B23Q 11/00

(52) U.S. Cl. CPC B23B 47/34; B23Q 11/0042

(57) ABSTRACT

A swinging system includes two gear trains each having two pinions, a first drive train and a second train driven by the first train, a first pinion of the first train engaging a first pinion of the second train, the second pinion of the first train engaging the second pinion of the second train, each pinion including a disk such that the disk of the first pinion of the second gear train is off-axis relative to the other pinion of the first gear train and one of the two disks includes a slug which fits into a groove arranged in the second disk. Thus, the speed of rotation of the first pinion of the second train varies relative to the speed of rotation of the first pinion of the second train.

The present invention relates to kinematics that make it possible to create a reciprocating axial or back-and-forth or vibratory movement.

The principle used in the art is to add an axial oscillatory movement, also referred to as a vibratory movement, to the cutting movement of the tool. The oscillatory or vibratory movement is defined by two main parameters: the amplitude and the frequency of the oscillations.

Usually applied to operations of the drilling type (which includes drilling, boring, reaming), this technique makes it possible to vary the pass depth increment of the tool cyclically. The pass depth increment is the process parameter that allows chip thickness to be regulated.

Drilling is defined as a machining operation performed with continuous cutting.

That implies that the cross section of the chip remains constant over time. By contrast, in vibratory drilling, the chip thickness at the instant t₁ will differ from that at the instant t₂. Moreover, it is found that this thickness can be forced to zero at finite moments in time leading to the interruption of the formation of the ribbon of chip. The chip will then no longer be continuous but will be “fragmented”.

The distinction between the technique of vibratory drilling and the technique using chip-fracture cycles (e.g.: chip-clearing cycles) lies in the frequency of the back-and-forth axial movement. In the case of chip-fracture cycles this will systematically be higher than the rotational frequency of the tool. The chip will therefore not have a fragmented morphology but will rather be short or even medium-long.

Vibratory-mode drilling is used in deep drilling or boring operations in order to limit the risks of the chips becoming jammed in the flutes of the tool. In addition to improving chip removal, other more recent uses employ the vibratory technique in order to reduce the heating of the tool.

The existence of vibratory drilling devices is known from publications FR 2 907 695, DE 10 2005 002 462, FR 2 902 848 and WO 2011/061 678 which are incorporated by reference. The mechanical systems proposed use cam technology in various ways.

In application FR 2 907 695, the oscillations are generated by cams without rolling members. This results in friction at the cam, causing heating and noise. Furthermore, the optimal vibrational frequency for correct chip fragmentation is not always reached because this frequency is an integer multiple of the rotational speed of the feed pinion with respect to the spindle or with respect to the structure.

In patent DE 10 2005 002 462, a spring applies a return force to a rolling bearing comprising an undulating surface, in a drill bit feed direction, so as to produce axial vibrations. In the event of high axial pressure on the drill bit, the rolling members may stop rolling over the undulating surface, and the drill bit ceases to oscillate. In order to avoid this disadvantage, the spring needs to have significant spring stiffness, something which may require the rolling-bearing system to be oversized. This then results in a significant cost.

Finally, patent application WO 2011/061678 affords an improved technical solution to the aforementioned systems. First of all, the proposed vibratory system has rolling members that allow friction to be limited. The number of vibratory periods per spindle revolution is a non-integer number defined by the geometry of the cam and remains constant during the period. The advantage of a non-integer number means the avoidance of a parallel path of the cutting edges during the drilling is possible and increases the efficiency with which the chips are fragmented.

However, the use of vibratory technology employing cams does not allow optimal oscillatory movements to be achieved because the options for adjusting the frequency and amplitude are limited by the shape of the cam and the precision with which it is machined. This notably entails the use of a high amplitude when drilling at low feed rates thus applying severe mechanical stress to the machining system. Furthermore, the costs associated with machining and also with cam wear and breakages are not negligible.

For example, in the case of multi-material drilling, which is often encountered in the aeronautical industry, the technical properties of each material, notably the hardness, differ, making it necessary to adjust the tool to suit the material that is the most demanding.

For accessibility reasons, aeronautical drilling is often performed using portable drilling units. Vibratory technology needs therefore to be able to be incorporated into these compact drilling systems.

A drilling unit is a tool control device. Application FR 2 881 366 describes a drilling device comprising two gear sets and incorporated by reference. The first set is made up of a drive pinion and of a spindle pinion; it allows a rotational movement to be imparted to the spindle by means of a sliding connection. The second set is made up of a dog clutch pinion and a feed pinion. The latter is in a helicoidal connection with the spindle.

During the drilling phase, the dog clutch pinion couples with the drive pinion which drives the rotation thereof. Once in motion, the dog clutch pinion will drive the rotation of the feed pinion. The differential in speed between the spindle and feed pinions will create the spindle feed movement. When the backing phase of the spindle begins, the dog clutch pinion disengages from the drive pinion to engage with the structure of the drilling device. The dog clutch and feed pinions therefore stop turning. As the spindle continues to turn it will, because the helicoidal connection is fixed, move in the opposite direction and therefore back up.

It is the object of the present invention to propose a simple solution that makes it possible to create a variation in cyclic speed between two gear sets in order to allow an oscillatory movement of the spindle placed on a shaft.

The oscillatory system according to the invention comprises two gear sets each with two pinions, a first set for driving and a second set driven by the first set, a first pinion of the first set collaborating with a first pinion of the second set, the second pinion of the first set is mounted by a sliding connection on the same shaft or spindle as the second pinion of the second set, said second pinion of the second set being mounted via a helicoidal connection on said shaft, each pinion comprising a disk with an axis of rotation; the system is characterized in that the disk of the first pinion of the second gear set has its axis offset with respect to the first pinion of the first gear set and that one of the two disks comprises a pin that enters a slot arranged in the second disk. Thus, the rotational speed of the first pinion of the second set varies cyclically with respect to the rotational speed of the first pinion of the first set.

According to one particular feature, the slot has a length equal to at least twice the axis offset of the two disks, preferably twice the axis offset plus the width of the pin. The use of a pin in a slot allows the two pinions to be connected by an annular linear connection.

According to a first arrangement, the pin is placed on the disk of the first pinion of the second set and that the slot is placed on the disk of the first pinion of the first set. With this configuration, the pin is placed on the driven disk while the slot is on the drive disk, giving the tool a near-sinusoidal vertical movement.

According to a second arrangement, the pin is placed on the disk of the first pinion of the first set and that the slot is placed on the disk of the first pinion of the second set. With this configuration, the pin is placed on the drive disk while the slot is on the driven disk thereby giving the tool a hybrid oscillatory vertical movement in which the upward and downward movements of the tool are asymmetric.

According to another arrangement, the axis offset of the two disks is adjustable. The amplitude of the vibrations can thus also be adjusted by virtue of the axis offset of the pinions which is chosen when the machine is set up.

According to one particular feature, an auxiliary system controls the axis offset. This auxiliary system makes it possible both to control the axis offset and also to activate and deactivate the vibratory mode at any instant without the need to dismantle the machine. The offsetting of the axes takes place in a circular path, the center of rotation of which coincides with the axis of the spindle so as to guarantee correct meshing of the pinions.

According to another feature, the maximum offset is strictly less than half the radius of the disk comprising the slot allowing coupling with the pin. For small amplitudes and to maintain a certain compactness of the machine, the various ratios in the kinematics are set so that the axis offset is strictly greater than 0 and less than 3 mm (this range of adjustment being nonlimiting).

According to a first alternative form, the oscillatory system is a vibratory machine comprises an oscillatory system as described above, characterized in that it comprises a motor, a spindle and a tool support: the first pinion of the first set collaborates with the motor. In this case, the first pinion of the second set is a dog clutch pinion and the disks of the dog clutch pinion and of the drive pinion have their axes offset from one another. Because the two pinions have their axes offset, the distance between the peripheral pin belonging to one of the pinions and the axis of the other pinion will be constantly changing. The instantaneous angular position of the dog clutch pinion will therefore oscillate about that of the drive pinion.

According to another feature, the dog clutch pinion collaborates with an auxiliary system allowing the spindle to return. The auxiliary system may for example be a hydraulic piston which moves the dog clutch pinion in such a way as to disengage it from the drive pinion. The dog clutch pinion will therefore no longer be driven in rotation and this will immobilize the feed pinion and cause the spindle to back up.

According to one particular arrangement, the pin is adjustable. It is possible to position the pin at the desired distance when setting up the dog clutch pinion, and this means that the same mechanism will be able to be used even if the axis offset is great and means that the amplitude of the oscillations can be adjusted. The amplitude of the oscillations being determined by the ratio of the axis offset E to the distance r of the pin with respect to the axis of rotation of the dog clutch pinion.

According to a second alternative form, it is a vibratory tool holder such that the motor collaborates with the spindle which drives the driving set and the driven set. The feed and rotational movements of the spindle are produced by two distinct motors. Thus, the vibratory mechanism will be driven by the motor also referred to as the spindle motor and will have the function of creating a cyclic variation of the position of the tool with respect to the spindle. The feed motor on the other hand will provide tool feed independently of the spindle motor.

Further advantages may become more apparent to those skilled in the art from reading the following examples, illustrated by the attached figures given solely by way of example.

### BRIEF DESCRIPTION OF THE FIGURES

| | |
|---|---|
| FIG. 1 | depicts a machine tool of the |
| | prior art, |
| FIG. 2 | shows the axis offset between the |
| | two pinions, |
| FIG. 3 | details the relationship between |
| | the two pinions, |
| FIG. 4 | illustrates a first embodiment, |
| FIG. 5 | illustrates a second embodiment, |
| FIG. 6 | shows the path of the axial |
| | displacement of the tool as a |
| | function of pin position. |

The machine tool of the prior art illustrated in FIG. 1 comprises a structure 1 which partially houses a spindle or a shaft 2 and a drive system 3, here the drive system 3 also provides the spindle 2 feed. The drive system 3 is coupled with a motor (not depicted). In a vibratory tool holder drive is provided by a second motor referred to as the feed motor. The spindle 2 drives a tool holder equipped with a drill bit or milling cutter for performing axial machining. The spindle 2 comprises a pinion 4 which rotates with it while at the same time allowing axial displacement of said pinion 4 along the spindle 2, for example via a sliding connection. The pinion 4 is rotationally driven about an axis X by a pinion 5 with axis of rotation Y and which coupled to a drive motor. The spindle 2 also comprises a feed pinion 7 able to move axially along the axis X. The feed pinion 7 is rotationally driven by a pinion 6 with axis of rotation Y.

The feed pinion 7 comprises a screw thread 71 screwed onto a threaded portion of the spindle 2 such that a rotation of the feed pinion 7 relative to the spindle 2 causes the axial displacement of the latter. The pinion 6 is coupled by a dog clutch with the pinion 5 and can be automatically uncoupled from the pinion 5 at the end of the downward travel so as to allow the spindle 2 to back up.

The pinion 6 drives the feed pinion 7 at a rotational speed that differs slightly from that of the pinion 4 so as to generate the feed movement for the spindle 2.

The pinion 6 is connected to a piston 8. When the piston 8 is displaced downward, the pinion 6 is uncoupled from the pinion 5 and the spindle 2 can then perform its backing-up movement.

FIG. 2 shows the axis offset between the two pinions 5 and 6. The two pinions 4 and 7 rotate about the same axis X which drives them both, whereas the pinions 5 and 6 have their axes offset and rotate respectively about an axis O₅ and O₆ which are parallel and offset from one another by a distance E. Each pinion 4, 5, 6 and 7 respectively constitutes a disk 40, 50, 60 and 70. Each disk is bordered by toothsets (not depicted) to allow for the driving of the pinions 5 and 4 and of the pinions 6 and 7.

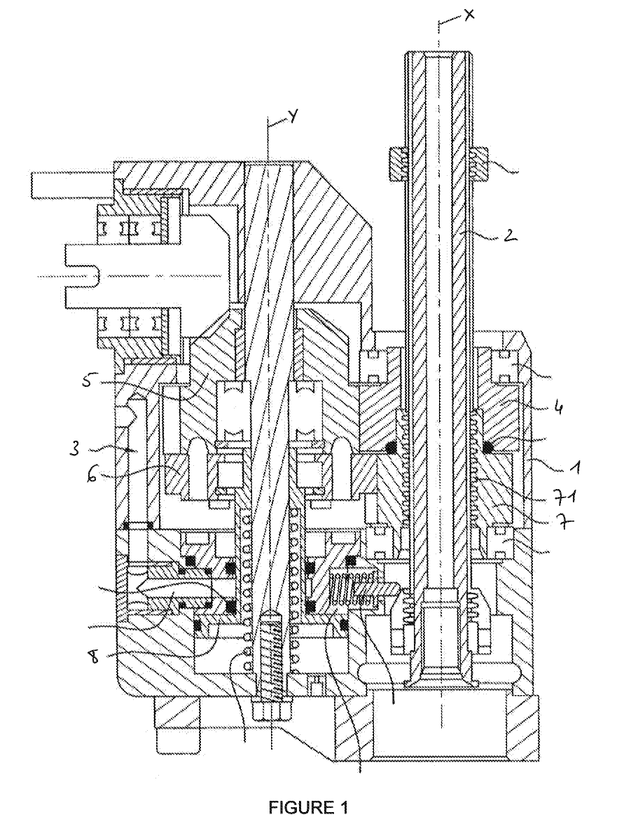

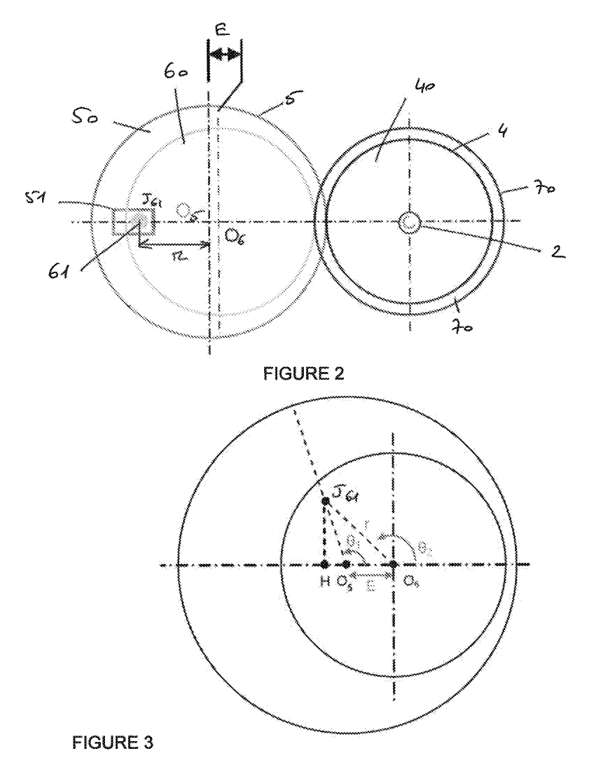

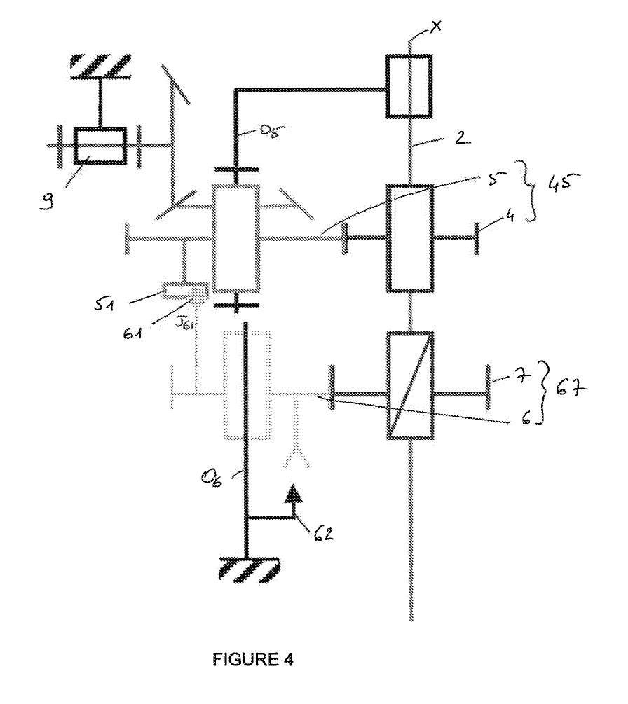

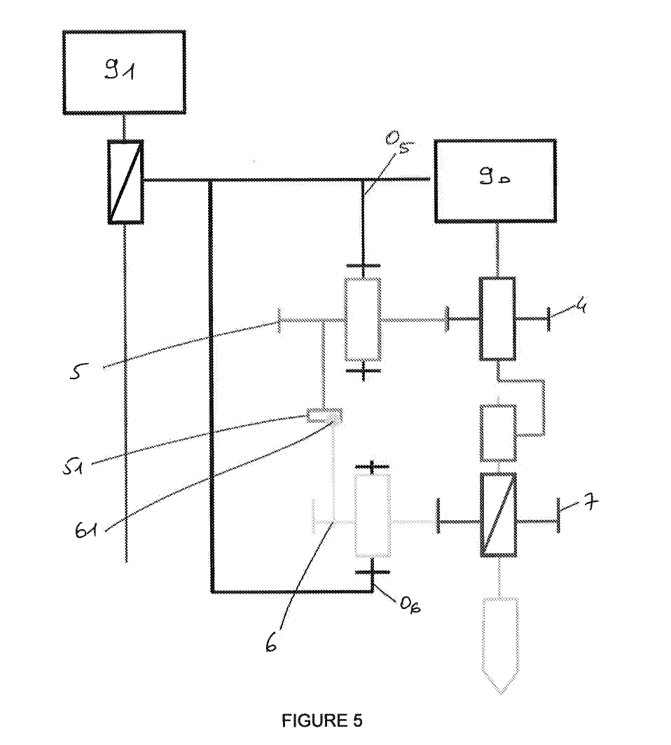

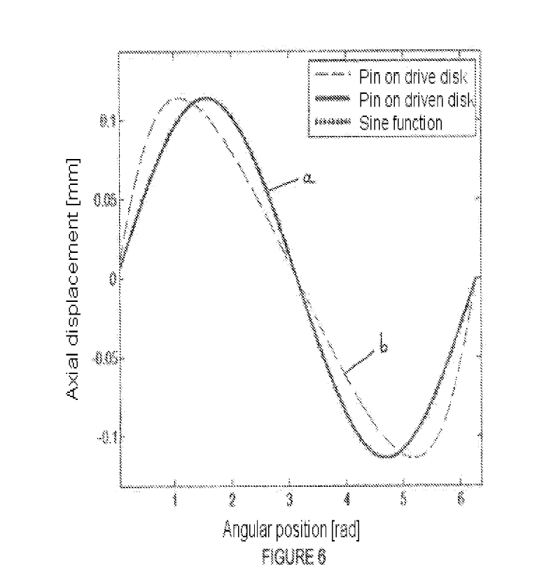

A pin 61 of center J₆₁, arranged on the disk 60 at a distance r from the center of the disk 60 and secured to this disk, slides in an aperture 51 made in the disk 50. As the disk 50 rotates, the disk 60 is driven as follows: the aperture 51 rotates with the disk 50, the pin 61 is driven with the aperture 51 and this makes the disk 60 turn, but because the two disks 50 and 60 have their axes offset, the pin 61 needs to be able to slide by twice the axis offset distance E, because between two opposite positions of the pin 61 the travel is twice the distance between the two axes O₅ and O₆.

Because the two pinions 5 and 6 have their axes offset, the distance between the pin 61 and the axis of rotation O₅ of the pinion 5 will be constantly changing. The angular position of the pinion 6 will oscillate with respect to that of the pinion 5.

The relationship connecting the angular position of the pinions 5 and 6 can be determined geometrically (FIG. 3). The angular position of the pin 61 is defined by an angle θ₂, measured from a horizontal axis x. The distance d between O₅ and J₆₁ is as a function of θ₂, r and E, using the generalized theorem of Pythagoras.

This then gives equation (1):

d²=r²+E²−2·r·E·cos(θ₂)

Because and

HJ₆₁=O₅J₆₁·sin(θ₁);HJ₆₁=r·sin(θ₂)

O₅J₆₁ can also be expressed using equation (2):

$${O}_{5} {J}_{61}^{2} = \frac{{r}^{2} \cdot ( 1 - {cos}^{2} ( {θ}_{2} ) )}{{sin}^{2} ( {θ}_{1} )}$$

From equations (1) and (2) it is possible to arrive at the second-degree equation (3) as follows:

$$\frac{{r}^{2}}{{sin}^{2} ( {θ}_{1} )} \cdot {cos}^{2} ( {θ}_{2} ) - 2 \cdot r \cdot E \cdot cos ( {θ}_{2} ) + ( {r}^{2} + {E}^{2} - \frac{{r}^{2}}{{sin}^{2} ( {θ}_{1} )} ) = 0$$

This equation allows the reduced discriminant:

Δ′=r² cos²(θ₁)(r²−E²·sin²(θ₁))

Because the axis offset (E) is smaller than the value of the radius (r), equation (3) has two roots.

This then gives equation (4):

$$cos ( {θ}_{2} ) = \frac{E {sin}^{2} ( {θ}_{1} ) \pm cos ( {θ}_{1} ) \cdot \sqrt{{r}^{2} - {E}^{2} \cdot {sin}^{2} ( {θ}_{1} )}}{r}$$

The continuity of cos (θ2) and the boundary conditions mean that just one solution can be adopted, this being equation (5):

$$cos ( {θ}_{2} ) = \frac{E {sin}^{2} ( {θ}_{1} ) + cos ( {θ}_{1} ) \cdot \sqrt{{r}^{2} - {E}^{2} \cdot {sin}^{2} ( {θ}_{1} )}}{r}$$

This culminates in equation (6):

$${θ}_{2} ( {θ}_{1} ) = \pm a cos ( \frac{E {sin}^{2} ( {θ}_{1} ) + cos ( {θ}_{1} ) \cdot \sqrt{{r}^{2} - {E}^{2} \cdot {sin}^{2} ( {θ}_{1} )}}{r} ) [ 2 π ]$$

The amplitude of the oscillations will be adjusted by means of the E/r ratio. Large oscillations will be obtained when the ratio is large and conversely small oscillations when the ratio is small. The vibrational frequency will be adjusted using the ratio of speed between the pinions 4 and 5. The value of the ratio will give the number of oscillations per revolution. Thus, the higher the ratio, the higher the vibrational frequency.

In the first embodiment illustrated in FIG. 4, the pinion 5 is a drive pinion driven by the motor 9, the pinion 6 is a dog clutch pinion. It comprises two gear sets 45 and 67. The first set 45 is made up of a drive pinion 5 and of a spindle pinion 4. This set allows rotational movement to be imparted to the spindle 2. The second set 67 is made up of a dog clutch pinion 6 and of a feed pinion 7. The latter pinion 7 is in a helicoidal connection with the spindle 2. During the drilling phase, the dog clutch pinion 6 becomes coupled to the drive pinion 5 which drives it in rotation. Once in motion, the dog clutch pinion 6 will drive the rotation of the feed pinion 7. The speed differential between the pinions 4 and 7 will create the feed and vibratory movements of the spindle 2. As the phase in which the spindle 2 backs up begins, the dog clutch pinion 6 becomes disconnected from the drive pinion 5 to settle into the structure 1 of the drilling device through the action of an auxiliary system 62 such as a piston. The pinions 6 and 7 therefore stop turning. The spindle 2 by continuing to rotate will, by virtue of the fact that the helicoidal connection is fixed, travel in the opposite direction.

In a second embodiment illustrated in FIG. 5, the pinion 4 is rotationally driven by a spindle motor 90, spindle feed being achieved separately by a feed motor 91. The principle of operation is the same as for the first alternative form although, because the feed is achieved by a separate motor, there is no longer any need for the second pinion 6 to be able to disconnect from the pinion 5.

It may be seen from FIG. 6 that the path of the axial displacement of the tool is a function of which of the two disks of the first pinions the pin possesses. If the pin is on the driven disk, curve a is sinusoidal, whereas if the pin is on the drive disk, curve b is asymmetric. Of course, the invention is not restricted to the examples illustrated, it being possible for the vibratory system to be installed on any drilling, turning, milling device. It may also be installed on a wood-welding system as described in patent application FR2939341.

1.-12. (canceled)

13. An oscillatory system comprising two gear sets each with two pinions, a first set for driving and a second set driven by the first set, a first pinion of the first set collaborating with a first pinion of the second set, the second pinion of the first set is mounted by a sliding connection on the same shaft as the second pinion of the second set, the second pinion of the second set being mounted via a helicoidal connection on the shaft, each pinion comprising a disk with an axis of rotation such that the disk of the first pinion of the second gear set has its axis offset with respect to the other pinion of the first gear set and one of the two disks comprises a pin that enters a slot arranged in the second disk.

14. The oscillatory system of claim 13, wherein the slot has a length equal to at least twice the axis offset of the two disks.

15. The oscillatory system of claim 13, wherein the axis offset of the two disks is adjustable.

16. The oscillatory system of claim 15, wherein an auxiliary system controls the axis offset.

17. The oscillatory system of claim 13, wherein the pin is placed on the disk of the first pinion of the first set and the slot is placed on the disk of the first pinion of the second set.

18. The oscillatory system of claim 13, wherein the pin is placed on the disk of the first pinion of the second set and the slot is placed on the disk of the first pinion of the first set.

19. The oscillatory system of claim 13, wherein the slot has a length equal to twice the axis offset plus the width of the pin

20. A vibratory machine comprising the oscillatory system of claim 13, a motor, a spindle, and a tool support, wherein the first pinion of the first set collaborates with the motor.

21. The machine of claim 20, wherein the second pinion is a dog clutch pinion and the disks of the dog clutch pinion and of the first pinion have their axes offset from one another.

22. The machine of claim 21, wherein the dog clutch pinion collaborates with an auxiliary system allowing the spindle to return.

23. The machine of claim 22, wherein the dog clutch pinion is configured for translational movement parallel to its axis of rotation.

24. The machine of claim 23, wherein the pin is adjustable.

25. A vibratory tool holder comprising the oscillatory system of claim 13, the tool holder comprising a motor that collaborates with a spindle to the drive pinion and the feed pinion and a feed motor.
